(19) United States
(12) Patent Application Publication
(10) Pub. No.: US 2025/0113346 A1
(43) Pub. Date: Apr. 3, 2025

(54) TECHNOLOGIES FOR SUPPORTING EIGHT TRANSMIT UPLINK OPERATION

(71) Applicant: Apple Inc., Cupertino, CA (US)

(72) Inventors: Haitong Sun, San Diego, CA (US); Ankit Bhamri, Haar (DE); Chunxuan Ye, San Diego, CA (US); Dawei Zhang, Saratoga, CA (US); Sigen Ye, San Diego, CA (US); Wei Zeng, Saratoga, CA (US); Weidong Yang, San Diego, CA (US); Xiang Chen, Campbell, CA (US)

(73) Assignee: Apple Inc., Cupertino, CA (US)

(21) Appl. No.: 18/818,480

(22) Filed: Aug. 28, 2024

Related U.S. Application Data
(60) Provisional application No. 63/586,391, filed on Sep. 28, 2023.

(51) Int. Cl. H04W 72/044; H04L 5/00; H04W 72/232

(52) U.S. Cl. CPC H04W 72/0466; H04L 5/0048; H04W 72/232

(57) ABSTRACT

The present application relates to devices and components including apparatus, systems, and methods for supporting eight transmitter uplink operation.

### CROSS-REFERENCES TO RELATED APPLICATIONS

This application claims the benefit of U.S. Provisional Patent Application No. 63/586,391, filed on Sep. 28, 2023, which is herein incorporated by reference in its entirety for all purposes.

### BACKGROUND

Third Generation Partnership Project (3GPP) Technical Specifications (TSs) define standards for wireless networks. These TSs describe aspects related to providing multiple-input, multiple-output (MIMO) communication over a radio interface.

### BRIEF DESCRIPTION OF THE DRAWINGS

FIG. 1 illustrates a network environment in accordance with some embodiments.

FIG. 2 illustrates antenna architectures in accordance with some embodiments.

FIG. 3 illustrates a slot transmission in accordance with some embodiments.

FIG. 4 illustrates another slot transmission in accordance with some embodiments.

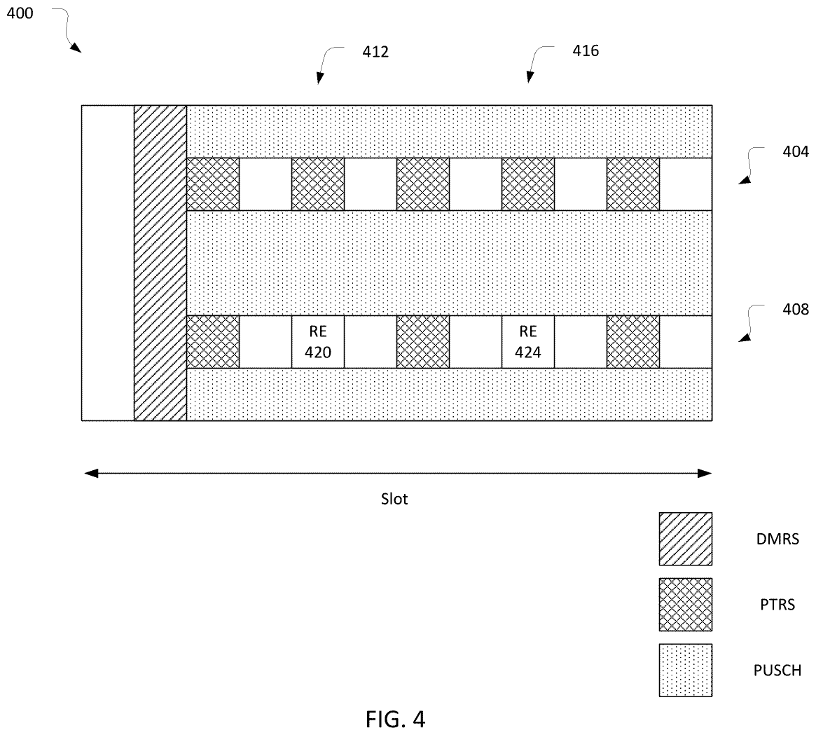

FIG. 5 illustrates an identity matrix in accordance with some embodiments.

FIG. 6 illustrates a table in accordance with some embodiments.

FIG. 7 illustrates a user equipment in accordance with some embodiments.

FIG. 8 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

Current 3GPP new radio (NR) systems support two operation modes for uplink multiple-input, multiple-output (MIMO) operation. The first uplink MIMO operation mode may be a codebook-based uplink in which a sounding reference signal (SRS) resource set usage is set to “codebook.” In this operation mode, a UE may transmit an SRS resource with a plurality of ports. A base station may then schedule a physical uplink shared channel (PUSCH) transmission by providing a precoding information and number of layers (PL) field in DCI to indicate precoding information (for example, a transmitted precoding matrix indicator (TPMI)) and a number of layers (for example, a rank indicator (RI)). The base station may also provide an SRS resource indicator (SRI) to select the SRS resource that is used as a reference for the information conveyed by the PL field.

Current NR systems may support three coherency modes for codebook UL MIMO operation: non-coherent, in which a codebookSubset=“nonCoherent”; partial coherent, in which a codebookSubset=“partialAndNonCoherent”; and full coherent, in which a codebookSubset=“fullyAndPartialAndNon-Coherent.”

The second uplink MIMO operation mode may be a non-codebook-based uplink in which a SRS resource set usage is set to “non-Codebook.” In this operation mode, a UE may measure channel state information-reference signals (CSI-RS) and use these measurements to derive precoding weights for configured SRS resources. This operation mode assumes downlink-uplink channel reciprocity. The UE may then transmit a plurality of SRS resources from a corresponding plurality of ports using its calculated precoding weights. The base station may then schedule a PUSCH transmission by providing an SRI in the scheduling DCI to indicate an SRS resource/port selection (and precoding matrix used for selected SRS transmission) and a number of layers (for example, RI).

In current NR systems, uplink MIMO operation is supported for up to a maximum of four transmitters (Tx) with a maximum of four transmissions layers for the PUSCH. Embodiments of the present disclosure describe systems to enable uplink MIMO operation that supports 8 Tx PUSCH operation.

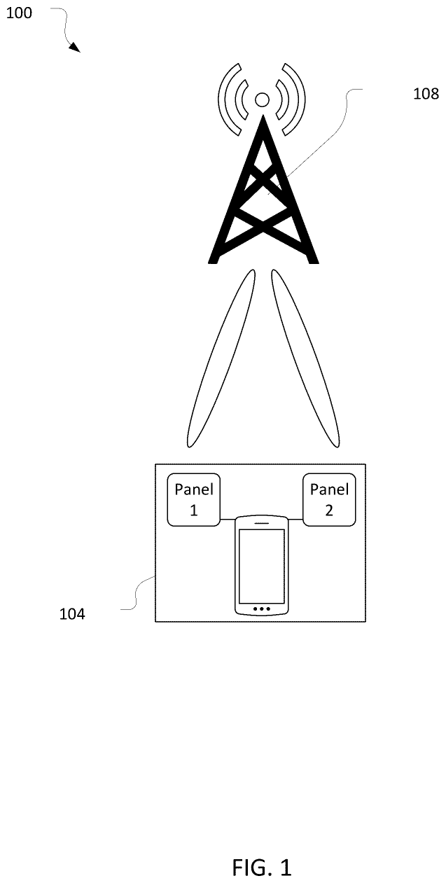

FIG. 1 illustrates a network environment 100 in accordance with some embodiments. The network environment 100 may include a user equipment 104 and a base station 108. In some embodiments, the base station 108 may provide one or more wireless access cells through which the UE 104 may communicate with a cellular network.

The UE 104 and the base station 108 may communicate over air interfaces compatible with Fifth Generation (5G) NR or later system standards as provided by 3GPP TSs.

The UE 104 may include one or more antenna panels with individual antenna panels having an array of antenna elements. As shown, the UE 104 has two antenna panels, panel 1 and panel 2. The UE 104 may use panel 1 and panel 2 to simultaneously transmit uplink signals in a spatial-domain multiplexing (SDM) manner.

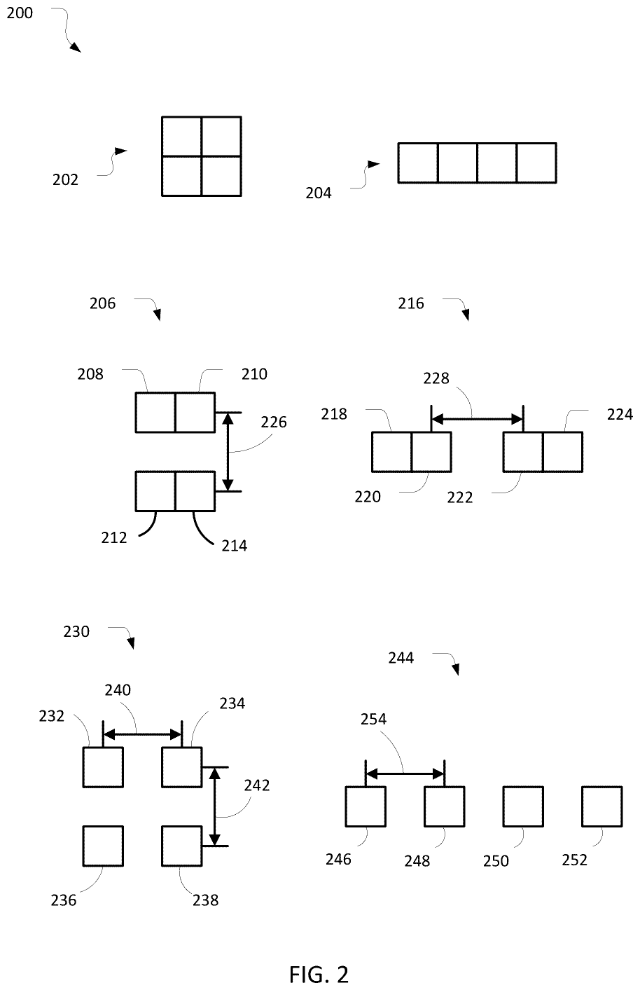

FIG. 2 illustrates example antenna architectures 200 in accordance with some embodiments. In particular, the antenna architectures 200 may illustrate arrangements of antennas that may be implemented within the UE 104. Each of the squares in the illustrated antenna architectures 200 may represent an antenna location, where each of the antenna locations has two antenna elements, for example, one element for a horizontal polarization and one for a vertical polarization. Accordingly, one antenna location may provide two Tx UL operation and may support two layers.

The arrangement of the antenna elements of the different antenna architectures 200 may provide different coherency relationships to the antenna ports that are coupled with the antenna elements. This may be due to the dependency of the phase noise source on the location of the antenna elements in the antenna architectures. Each antenna architecture may be associated with a number of coherent antenna port groups, referred to as N_g, with each antenna port group containing 8/N_g coherent antenna ports. Antenna ports in the same coherent antenna port group are coherent with one another. Antenna ports in different coherent antenna port groups are noncoherent with one another.

The antenna architectures 200 may include two full-coherent arrangements, for example, antenna arrangement 202 and antenna arrangement 204. In the antenna arrangement 202, all of the antennas locations are located adjacent to each other to form a square. In the second antenna arrangement 204, the antenna locations are located adjacent to each other to form a line. Given that the antenna locations of the first antenna arrangement 202 and the second antenna arrangement 204 are located adjacent to one another, they may each be associated with a single phase noise source. Thus, these arrangements provide one coherent antenna port group (N_g=1) with all the antenna ports of the coherent antenna port group being coherent with one another.

The antenna architectures 200 may further include two partial-coherent 2 (PartialCoherent2) arrangements, for example, antenna arrangement 206 and antenna arrangement 208. The third antenna arrangement 206 may include a first set of antenna locations (for example, antenna locations 208 and 210) and a second set of antenna locations (for example, antenna locations 212 and 214). The first and second sets may be separated by a distance 226 and may each be associated with different phase noise sources. Similarly, the antenna arrangement 206 may include a first set of antenna locations (for example, antenna locations 218 and 220) and a second set of antenna locations (for example, antenna locations 222 and 224) separated by a distance 228 and associated with different phase noise sources. Thus, the PartialCoherent2 arrangements 206 and 216 provide two coherent antenna port groups (N_g=2), each having four antenna ports.

The antenna architectures 200 may further include two partial-coherent 4 (PartialCoherent4) arrangements, for example, antenna arrangement 230 and antenna arrangement 244. The antenna arrangement 230 may include four antenna locations (for example, antenna locations 232, 234, 236, and 238) separated in a first direction by distance 242 and a second direction by 240. Each of the four antenna locations may be associated with a different phase noise source. Similarly, the antenna arrangement 244 may include four antenna locations (for example, antennas, 246, 248, 250, and 252) arranged in one direction and separated from adjacent antenna locations by a distance 254. Each of the four antenna locations of arrangement 244 may also be associated with a different phase noise source. Thus, the PartialCoherent4 arrangements 230 and 244 provide four coherent antenna port groups (N_g=4), each having two antenna ports.

A non-coherent architecture may include eight coherent antenna port groups, each containing one antenna port.

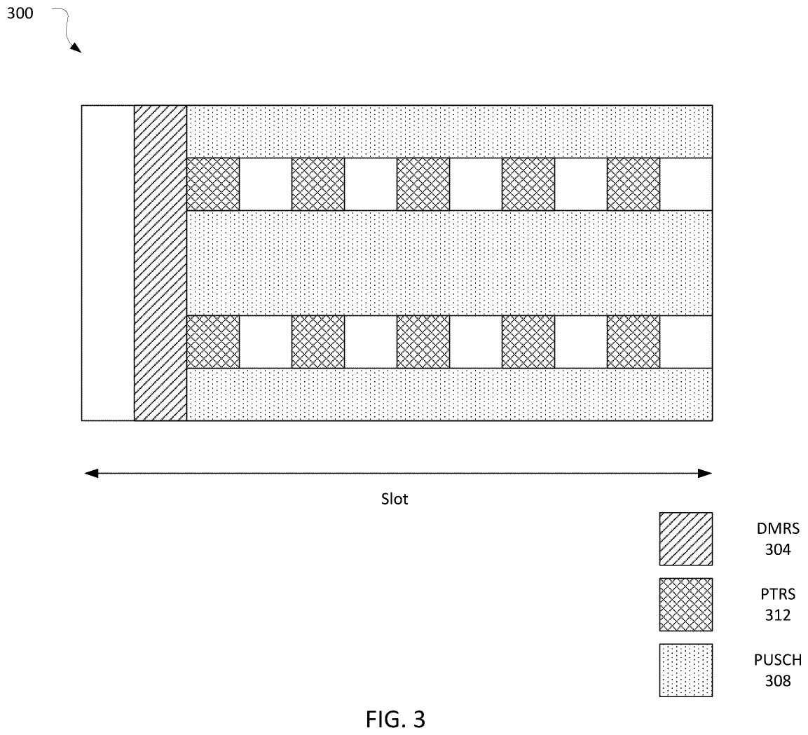

FIG. 3 illustrates a slot transmission 300 in accordance with some embodiments. The slot transmission 300 may include a demodulation reference signal (DMRS) 304, a PUSCH transmission 308, and a PTRS 312. The PTRS 312 may be inserted in orthogonal frequency division multiplexing (OFDM) symbols that do not include the DMRS 304. Phase noise may be change as a function of time more than as a function of frequency. Therefore, the PTRS 312 may have a higher density in the time domain than in the frequency domain.

The base station 108 upon receiving the slot transmission 300 may compensate for phase noise impact and phase shift in the DMRS 304 assuming the DMRS 304 and the PTRS 312 are transmitted with the same precoder. In particular, the receiver of the base station 108 may compare phase shift between the PTRS 312 and the DMRS 304 to calculate the phase offset, which may be used to compensate for the phase shift for all the subcarriers of the DMRS 304.

In current versions of 3GPP technical specifications, up to two PTRS ports may be supported. Two PTRS ports may be desirable if the UE 104 includes multiple antenna panels, given that local oscillators associated with each panel may be separate sources of phase noise and frequency offset.

Each PTRS port may be associated with a DMRS port, with the same digital precoder being applied for the PTRS and its associated DMRS. The two PTRS ports may be used for non-coherent/partial-coherent precoders.

The association between a PTRS port and a DMRS port may be provided through control signaling that provides the grant information. For example, for a dynamica grant PUSCH, the association between a PTRS port and a DMRS port may be indicated by a PTRS-DMRS association field in a scheduling DCI.

Various embodiments of the present disclosure provide design details to support 8 Tx uplink operations. A first aspect describes PTRS enhancement for 8 Tx UL operation. A second aspect describes full-power 8 Tx uplink operation. A third aspect describes size-reduction mechanisms for downlink control information (DCI) signaling.

With respect to the first aspect, a first option for PTRS enhancement for 8 Tx uplink operation may correspond to a situation in which the base station 108 configures a codebook-based 8 Tx uplink operation with a coherency mode configured as PartialCoherent2 (e.g., N_g=2) and a 2-port PTRS configured.

In the first option, the PTRS-DMRS association field in the scheduling DCI, which may have a DCI format 0_1 or 0_2 may be a four-bit field. In some embodiments, the four-bit field may provide a PTRS-DMRS association based on Table 1.

TABLE 1

| Value of 2 | | Value of 2 | |
|---|---|---|---|
| MSB | DMRS port | LSB | DMRS port |
| 00 | 1^{st} DMRS port which | 00 | 1^{st} DMRS port which |
| | shares PTRS port 0 | | shares PTRS port 1 |
| 01 | 2^{nd} DMRS port which | 01 | 2^{nd} DMRS port which |
| | shares PTRS port 0 | | shares PTRS port 1 |
| 10 | 3^{rd} DMRS port which | 10 | 3^{rd} DMRS port which |
| | shares PTRS port 0 | | shares PTRS port 1 |
| 11 | 4^{th} DMRS port which | 11 | 4^{th} DMRS port which |
| | shares PTRS port 0 | | shares PTRS port 1 |

Thus, the two MSBs may indicate which DMRS port of a first antenna panel are associated with PTRS port 0 and the two LSBs may indicate which DMRS port of a second antenna panel are associated with PTRS port 1. The four DMRS ports that share PTRS port 0 may be those that are transmitted by precoders applied over PUSCH antenna ports {1000, 1001, 1004, 1005}, as those PUSCH antenna ports may be associated with a first antenna panel. As used herein, “PUSCH antenna ports” may also be referred to as “SRS ports.” The four DMRS ports that share PTRS port 1 may be those that are transmitted by precoders applied over PUSCH antenna ports {1002, 1003, 1006, 1007}, as those PUSCH antenna ports may be associated with a second antenna panel.

It may be noted that an actual number of PTRS ports that are to be used to support an uplink transmission may be based on a TPMI indicated by the precoding information and number of layers field in the scheduling DCI format 0_1 or 0_2.

With respect to the first aspect, a second option for PTRS enhancement for 8 Tx uplink operation may correspond to a situation in which the base station 108 configures the UE 104 with a codebook-based 8 Tx uplink operation having a coherency mode configured as PartialCoherent4 (e.g., N_g=4) and a 2-port PTRS configured. The second option may work in a manner similar to the first option. For example, the PTRS-DMRS association field in the scheduling DCI format 0_1 or 0_2 may be a four-bit field that provides a PTRS-DMRS association based on Table 1.

In some embodiments, the DMRS ports that share PTRS ports 0 and 1 for the second option may also be similar to that described above with respect to the first option. For example, the DMRS ports that share PTRS port 0 may be those that are transmitted by precoders applied over PUSCH antenna ports {1000, 1001, 1004, 1005} and the four DMRS ports that share PTRS port 1 may be those that are transmitted by precoders applied over PUSCH antenna ports {1002, 1003, 1006, 1007}. However, given that the PartialCoherent4 coherency mode has four coherent antenna port groups, for example, {1000, 1004}, {1001, 1005}, {1002, 1006}, {1003, 1007}, the DMRS ports that share PTRS ports 0 and 1 may be provided in accordance with one of the following additional alternatives.

In a first alternative, the DMRS ports that share PTRS port 0 may be those that are transmitted with precoders applied over the PUSCH antenna ports {1000, 1002, 1004, 1006}, while the DMRS ports that share PTRS port 1 may be those that are transmitted with precoders applied over the PUSCH antenna ports {1001, 1003, 1005, 1007}.

In a second alternative, the DMRS ports that share PTRS port 0 may be those that are transmitted with precoders applied over the PUSCH antenna ports {1000, 1003, 1004, 1007}, while the DMRS ports that share PTRS port 1 may be those that are transmitted with precoders applied over the PUSCH antenna ports {1001, 1002, 1005, 1006}.

With respect to the first aspect, a third option for PTRS enhancement for 8 Tx uplink operation may correspond to a situation in which the base station 108 configures a codebook-based 8 Tx uplink operation with a coherency mode configured as PartialCoherent4 (e.g., N_g=4) and a 2-port PTRS configured.

In the third option, the PTRS-DMRS association field in the scheduling DCI format 0_1 or 0_2 may be a four-bit field. In some embodiments, the four-bit field may provide a PTRS-DMRS association based on Table 2.

TABLE 2

| Value | | Value | |
|---|---|---|---|
| of 2 | | of 2 | |
| MSB | DMRS port | LSB | DMRS port |
| 00 | 1^{st} DMRS port | 00 | 1^{st} DMRS port in 1^{st} subset |
| | in 1^{st} subset which | | |
| | shares PTRS port 0 | | which shares PTRS port 1 |
| 01 | 2^{nd} DMRS port | 01 | 2^{nd} DMRS port in 1^{st} subset |
| | in 1^{st} subset which | | |
| | shares PTRS port 0 | | which shares PTRS port 1 |
| 10 | 1^{st} DMRS port in 2^{nd} | 10 | 1^{st} DMRS port in 2^{nd} subset |
| | which subset shares | | which shares PTRS port 1 |
| | PTRS port 0 | | |
| 11 | 2^{nd} DMRS port in 2^{nd} | 11 | 2^{nd} DMRS port in 2^{nd} |
| | which subset shares | | subset which shares PTRS |
| | PTRS port 0 | | port 1 |

Table 2 relies on each set of DMRSs that share a particular PTRS port being divided into two subsets. For example, the set of four DMRS ports that share PTRS port 0 may include a first subset of DMRS ports that are transmitted by precoders applied over PUSCH antenna ports {1000, 1004}, for example, and a second subset of DMRS ports that are transmitted by precoders applied over PUSCH antenna ports {1001, 1005}. And the set of four DMRS ports that share PTRS port 1 may include a first subset of DMRS ports that are transmitted by precoders applied over PUSCH antenna ports {1002, 1006}, for example, and a second subset of DMRS ports that are transmitted by precoders applied over PUSCH antenna ports {1003, 1007}. Thus, a value of value of 0110 in the PTRS-DMRS association field would indicate that the DMRS port corresponding to PUSCH antenna port 1004 (second port from first subset of first set) is associated with PTRS port 0 and DMRS port corresponding to PUSCH antenna port 1003 (first port from second subset of second set) is associated with PTRS port 1.

In various embodiments, the four coherent antenna port groups may have any arbitrary order in terms of mapping to subset of DMRS ports sharing PTRS ports 0/1, for example, {1000, 1004}, {1001, 1005}, {1002, 1006}, {1003, 1007}.

With respect to the first aspect, a fourth option for PTRS enhancement for 8 Tx uplink operation may correspond to a situation in which the base station 108 configures the UE 104 with a codebook-based 8 Tx uplink operation having a coherency mode configured as PartialCoherent4 (e.g., N_g=4) or PartialCoherent2 (e.g., N_g=2) and a 2-port PTRS configured. The fourth option may work in a manner similar to the first option. For example, the PTRS-DMRS association field in the scheduling DCI format 0_1 or 0_2 may be a four-bit field that provides a PTRS-DMRS association based on Table 1.

In some embodiments, the DMRS ports that share PTRS ports 0 and 1 for the second option may be based on the ports used to transmit first and second codewords. For example, the DMRS ports sharing PTRS port 0 may be those DMRS ports associated with a first codeword and the DMRS ports sharing PTRS port 1 may be those DMRS ports associated with a second codeword.

It may be noted that an actual number of PTRS ports that are to be used to support an uplink transmission may be based on a TPMI indicated by the precoding information and number of layers field in the scheduling DCI format 0_1 or 0_2.

With respect to the first aspect, a fifth option for PTRS enhancement for 8 Tx uplink operation may correspond to a situation in which the coherency mode is configured as nonCoherent (e.g., N_g=8) and 2-port PTRS is configured. In this embodiment, the PTRS-DMRS association field in the scheduling DCI format 0_1 or 0_2 may be similar to the PartialCoherent2 (e.g., N_g=2) or PartialCoherent4 (e.g., N_g=4) embodiments described elsewhere herein.

With respect to the first aspect, a sixth option for PTRS enhancement for 8 Tx uplink operation may correspond to a situation in which 2-port PTRS is configured and two codewords are scheduled, with one PTRS port being associated with a first codeword and another PTRS port being associated with a second codeword.

If both PTRS ports have different time domain density, a symbol may have a PTRS transmission on only one PTRS port, with the resource element (RE) location corresponding to the other PTRS port not being transmitted due to having less time domain density. Consider, for example, the simplified slot transmission 400 of FIG. 400 in accordance with some embodiments. The PTRS for a first PTRS port at a first frequency location 404 may have a greater time-domain density than it does for a second PTRS port at a second frequency location 408. Thus, at symbols 412 and 416, the second frequency location may have REs 420 and 424, respectively, that do not have a PTRS. These REs may be handled in accordance with one of the following options.

In a first option, the REs 412 or 416 may be used to transmit DMRS.

In a second option, the REs 412 or 416 may be used to transmit PUSCH.

In a third option, the REs 412 or 416 may be empty, for example, transmission on those REs may be omitted.

The second aspect may provide full power 8 Tx uplink operation in accordance with a first or second option.

A first option may support full power mode 1 in a situation in which the base station 108 configures the UE 104 with a codebook-based 8 Tx PUSCH operation having a coherency mode configured as NonCoherent (e.g., N_g=8) and four transmission layers being configured (e.g., rank=4).

In some embodiments, a precoder may not be introduced to support full power transmission for rank=4.

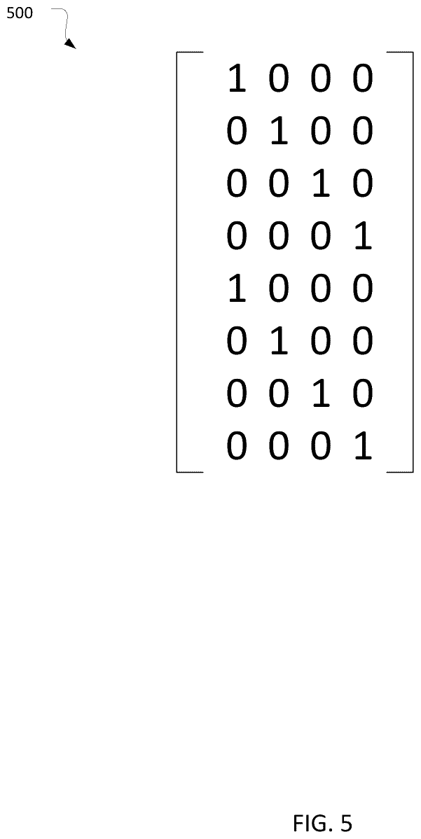

In other embodiments, an identity matrix may be used to support full power transmission for rank=4. FIG. 5 illustrates an identity matrix 500 that may be used to support full power transmission for rank=4. Based on identity matrix 500, two panels may be activated for every layer. Row permutation may be performed for the precoder.

With respect to the second aspect, a second option may be used to support full power mode 2 in a situation in which the base station 108 configures the UE 104 with a codebook-based 8 Tx PUSCH operation to support an SRS report set configured with one or more of 1-, 2-, 4-, or 8-port SRS resources.

In some embodiments, the UE 104 can further report a combination of a number of ports that can be configured for different SRS resources in an SRS resource set. This may be done in accordance with one or more of the following three options.

In a first option, the UE 104 reports one of the possible choices from {1, 2, 4, 1_2, 1_4, 2_4, 1_2_4}. The UE 104 may report ‘1’ to indicate the network can configure either 1-port SRS resource or 8-port SRS resource; report ‘2’ to indicate the network can configure either 2-port SRS resource or 8-port SRS resource; or report ‘4’ to indicate the network can configure either 4-port SRS resource or 8-port SRS resource. The UE 104 may report ‘1_2’ to indicate the network can configure either 1-port SRS resource, 2-port SRS resource, or 8-port SRS resource; report ‘1_4’ to indicate the network can configure either 1-port SRS resource, 4-port SRS resource, or 8-port SRS resource; or report ‘2_4’ to indicate the network can configure either 2-port SRS resource, 4-port SRS resource, or 8-port SRS resource. The UE 104 may report ‘1_2_4’ to indicate the network can configure either 1-port SRS resource, 2-port SRS resource, 4-port SRS resource or 8-port SRS resource.

In a second option, the UE 104 may report a 3-bit bitmap. Each bit of the bitmap may correspond to 1-port, 2-port or 4-port SRS resource. If the UE 104 reports the corresponding bit as ‘1,’ the network can configure the corresponding number of ports for SRS resource.

In a third option, the UE 104 may report a minimum or a maximum number of ports that can be configured for SRS resource among {1, 2, 4} ports.

The third aspect may provide DCI size reduction for situation in which the network configures codebook-based 8 Tx PUSCH operation and a coherency mode of FullCoherent (e.g., N_g=1). In this situation, a size of the precoding information and number of layers field in scheduling DCI format may be based on one or more of the following options.

In a first option, the number of bits of the precoding information and number of layers field may depend on a maximum rank (maxRank) that is configured in the PUSCH configuration. For example, when the maxRank is 1, the field may be four bits; when the maxRank is 2, the field may be six bits, and when the maxRank is 3, 4, 5, 6, 7, or 8, the field may be seven bits.

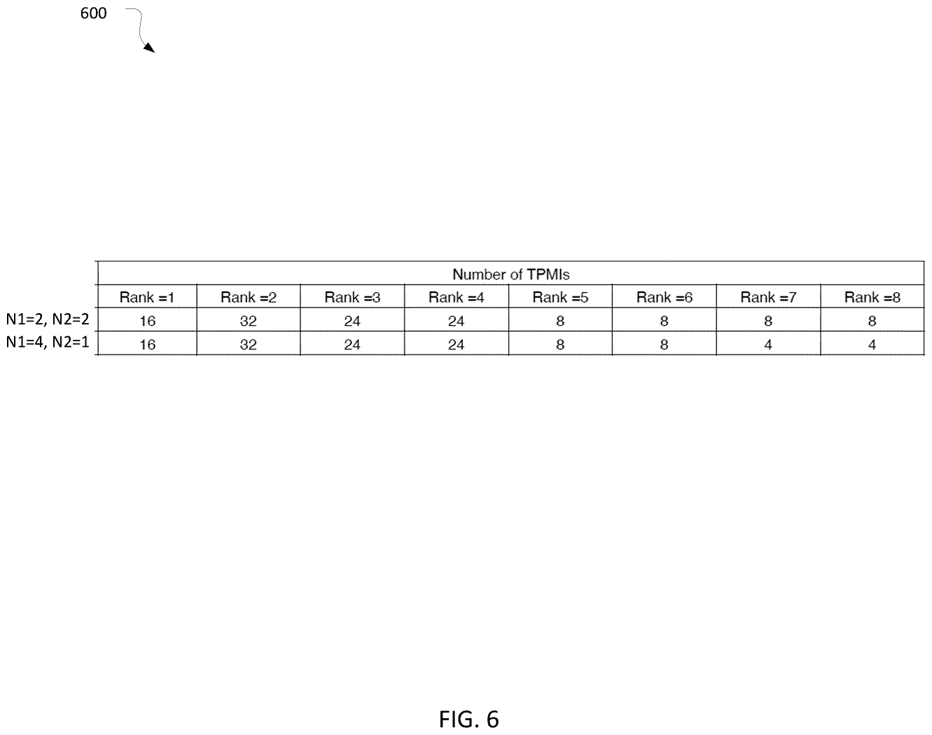

In some embodiments, the number of bits may be set equal to ┌log₂{Σᵣ₌₁^{maxRank}Nᵣ}┐, where r is a configured transmission rank, and Nᵣ is a number of TPMIs associated with the rank and an antenna configuration of the UE. In some embodiments, the number of TPMIs associated with the rank and the antenna configuration may be determined based on table 600 of FIG. 6 in accordance with some embodiments, where N1 is a number of antenna locations in a first (for example, vertical) direction and N2 is a number of antenna locations in a second (for example, horizontal) direction.

In a second option, the precoding information and number of layers field may always be seven bits regardless of the maxRank configuration.

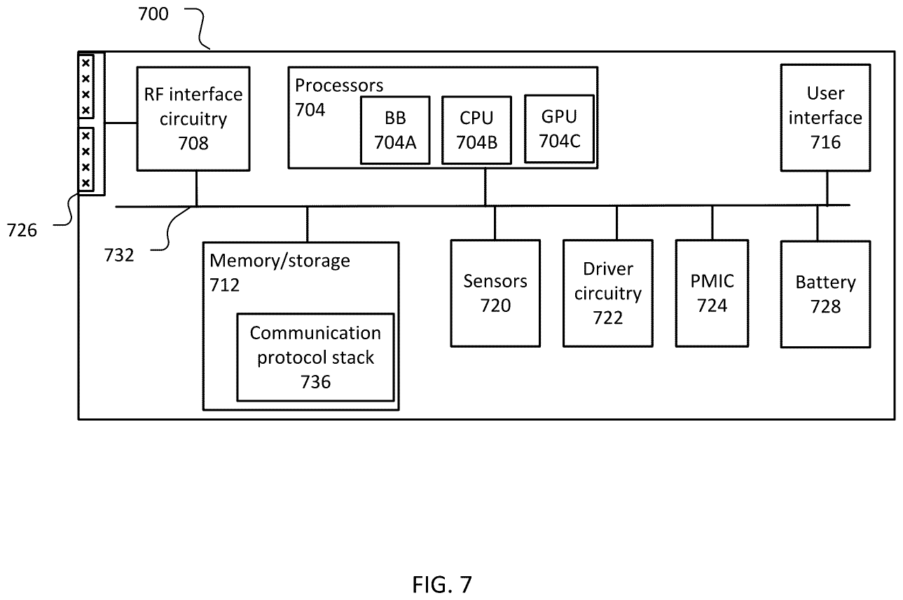

FIG. 7 illustrates an example UE 700 in accordance with some embodiments. The UE 700 may be any mobile or non-mobile computing device, such as, for example, a mobile phone, a computer, a tablet, an industrial wireless sensor (for example, a microphone, a carbon dioxide sensor, a pressure sensor, a humidity sensor, a thermometer, a motion sensor, an accelerometer, a laser scanner, a fluid level sensor, an inventory sensor, an electric voltage/current meter, or an actuators), a video surveillance/monitoring device (for example, a camera), a wearable device (for example, a smart watch), or an Internet-of-things (IoT) device.

The UE 700 may include processors 704, RF interface circuitry 708, memory/storage 712, user interface 716, sensors 720, driver circuitry 722, power management integrated circuit (PMIC) 724, antenna structure 726, and battery 728. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 732, which may represent any type of interface, input/output, bus (local, system, or expansion), transmission line, trace, optical connection, etc. that allows various circuit components (on common or different chips or chipsets) to interact with one another.

The processors 704 may include processor circuitry such as, for example, baseband processor circuitry (BB) 704A, central processor unit circuitry (CPU) 704B, and graphics processor unit circuitry (GPU) 704C. The processors 704 may include any type of circuitry or processor circuitry that executes or otherwise operates computer-executable instructions, such as program code, software modules, or functional processes from memory/storage 712 to cause the UE 700 to perform operations as described herein.

In some embodiments, the baseband processor circuitry 704A may access a communication protocol stack 736 in the memory/storage 712 to communicate over a 3GPP compatible network. In general, the baseband processor circuitry 704A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 708.

The baseband processor circuitry 704A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 712 may include one or more non-transitory, computer-readable media that includes instructions (for example, communication protocol stack 736) that may be executed by one or more of the processors 704 to cause the UE 700 to perform various operations described herein. The memory/storage 712 include any type of volatile or non-volatile memory that may be distributed throughout the UE 700. In some embodiments, some of the memory/storage 712 may be located on the processors 704 themselves (for example, L1 and L2 cache), while other memory/storage 712 is external to the processors 704 but accessible thereto via a memory interface. The memory/storage 712 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 708 may include transceiver circuitry and radio frequency front module (RFEM) that allows the UE 700 to communicate with other devices over a radio access network. The RF interface circuitry 708 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 726 and proceed to filter and amplify (with a low-noise amplifier) the signal. The signal may be provided to a receiver of the transceiver that down-converts the RF signal into a baseband signal that is provided to the baseband processor of the processors 704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 726.

In various embodiments, the RF interface circuitry 708 may be configured to transmit/receive signals in a manner compatible with NR or other access technologies.

The antenna 726 may include antenna elements to convert electrical signals into radio waves to travel through the air and to convert received radio waves into electrical signals. The antenna elements may be arranged into one or more antenna panels. The antenna 726 may have antenna panels that are omnidirectional, directional, or a combination thereof to enable beamforming and multiple-input, multiple-output communications. The antenna 726 may include microstrip antennas, printed antennas fabricated on the surface of one or more printed circuit boards, patch antennas, phased array antennas, etc. The antenna 726 may have one or more panels designed for specific frequency bands including bands in FR1 or FR2.

The user interface circuitry 716 includes various input/output (I/O) devices designed to enable user interaction with the UE 700. The user interface 716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 700.

The sensors 720 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 722 may include software and hardware elements that operate to control particular devices that are embedded in the UE 700, attached to the UE 700, or otherwise communicatively coupled with the UE 700. The driver circuitry 722 may include individual drivers allowing other components to interact with or control various input/output (I/O) devices that may be present within, or connected to, the UE 700. For example, driver circuitry 722 may include a display driver to control and allow access to a display device, a touchscreen driver to control and allow access to a touchscreen interface, sensor drivers to obtain sensor readings of sensor circuitry 720 and control and allow access to sensor circuitry 720, drivers to obtain actuator positions of electro-mechanic components or control and allow access to the electro-mechanic components, a camera driver to control and allow access to an embedded image capture device, audio drivers to control and allow access to one or more audio devices.

The PMIC 724 may manage power provided to various components of the UE 700. In particular, with respect to the processors 704, the PMIC 724 may control power-source selection, voltage scaling, battery charging, or DC-to-DC conversion.

In some embodiments, the PMIC 724 may control, or otherwise be part of, various power saving mechanisms of the UE 700. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 700 may power down for brief intervals of time and thus save power. If there is no data traffic activity for an extended period of time, then the UE 700 may transition off to an RRC_Idle state, where it disconnects from the network and does not perform operations such as channel quality feedback, handover, etc. The UE 700 goes into a very low power state and it performs paging where again it periodically wakes up to listen to the network and then powers down again. The UE 700 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 728 may power the UE 700, although in some examples the UE 700 may be mounted deployed in a fixed location, and may have a power supply coupled to an electrical grid. The battery 728 may be a lithium ion battery, a metal-air battery, such as a zinc-air battery, an aluminum-air battery, a lithium-air battery, and the like. In some implementations, such as in vehicle-based applications, the battery 728 may be a typical lead-acid automotive battery.

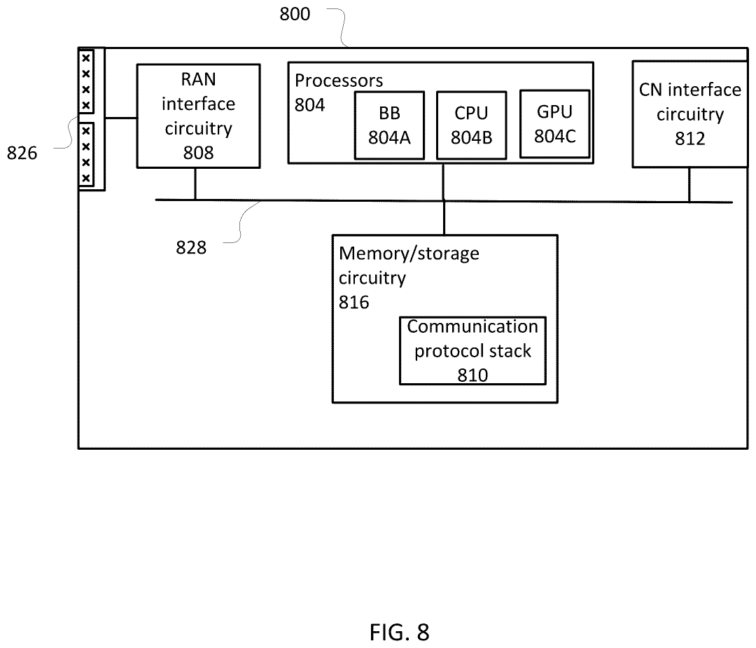

FIG. 8 illustrates an example base station 800 in accordance with some embodiments. The base station 800 may include processors 804, RF interface circuitry 808, core network (CN) interface circuitry 812, memory/storage circuitry 816, and antenna structure 826.

The components of the base station 800 may be coupled with various other components over one or more interconnects 828.

The processors 804, RF interface circuitry 808, memory/storage circuitry 816 (including communication protocol stack 810), antenna structure 826, and interconnects 828 may be similar to like-named elements shown and described with respect to FIG. 7.

The CN interface circuitry 812 may provide connectivity to a core network, for example, a 5th Generation Core network (5GC) using a 5GC-compatible network interface protocol such as carrier Ethernet protocols, or some other suitable protocol. Network connectivity may be provided to/from the base station 800 via a fiber optic or wireless backhaul. The CN interface circuitry 812 may include one or more dedicated processors or FPGAs to communicate using one or more of the aforementioned protocols. In some implementations, the CN interface circuitry 812 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### Examples

In the following sections, further exemplary embodiments are provided.

Example 1 includes a method of operating a user equipment (UE), the method comprising: receiving a physical uplink shared channel (PUSCH) configuration to configure codebook-based 8-transmitter (Tx) uplink operation; receiving, from a base station, downlink control information (DCI) to schedule a PUSCH transmission based on the PUSCH configuration; identifying up to eight demodulation reference signal (DMRS) ports associated with the PUSCH transmission; determining, based on the DCI, a first association between a first DMRS port of the up to eight DMRS ports and first phase tracking reference signal (PTRS) port; determining, based on the DCI, a second association between a second DMRS port of the up to eight DMRS ports and the second PTRS port; transmitting a PTRS using the first PTRS port based on the first association and using the second PTRS port based on the second association.

Example 2 includes the method of example one some other example herein, wherein the PUSCH configuration is to configure the codebook-based 8-Tx uplink operation with a partial coherent mode in which eight PUSCH antenna ports are arranged in two coherent antenna port groups.

Example 3 includes the method of example 2 or some other example herein, wherein the first DMRS port corresponds to a PUSCH antenna port 1000, 1001, 1004, or 1005 and the second DRMS port corresponds to a PUSCH antenna port 1002, 1003, 1006, and 1007.

Example 4 includes a method of example 1 some other example herein, wherein the PUSCH configuration is to configure the codebook-based 8-Tx uplink operation with a partial coherent mode in which eight antenna ports are arranged in four coherent antenna port groups.

Example 5 includes the method of example 4 some other example herein, wherein: the first DMRS port corresponds to sounding reference signal (SRS) port 1000, 1001, 1004, or 1005 and the second DRMS port corresponds to SRS port 1002, 1003, 1006, and 1007; the first DMRS port corresponds to SRS port 1000, 1002, 1004, or 1006 and the second DRMS port corresponds to SRS port 1001, 1003, 1005, and 1007; or the first DMRS port corresponds to SRS port 1000, 1003, 1004, or 1007 and the second DRMS port corresponds to SRS port 1001, 1002, 1005, and 1006.

Example 6 includes a method of example one some other example herein, further comprising: identifying, based on the DCI, a first precoder associated with the first DMRS port and a second precoder associated with the second DMRS port; transmitting the PTRS using the first PTRS port based on the first precoder and using the second PTRS based on the second precoder.

Example 7 includes a method of example 1 or some other example herein, wherein the DCI is DCI format 0_1 or 0_2 and comprises a PTRS-DMRS association field set with a four-bit value, and determining the first association and determining the second association is based on the four-bit value.

Example 8 includes the method of example 7 or some other example herein, wherein the up to eight DMRS ports include a first set of DMRS ports that correspond to a first coherent antenna port group and a second set of DMRS ports that correspond to a second coherent antenna port group, wherein two most significant bits of the four bit-value are to identify the first DMRS port from the first set of DMRS ports as being associated with the first PTRS port and two least-significant bits of the four bit-value are to identify the second DMRS port from the second set of DMRS ports as being associated with the second PTRS port.

Example 9 includes the method of example 7 or some other example herein, wherein the up to eight DMRS ports include a first set of DMRS ports that correspond to a first coherent antenna port group or a second coherent antenna port group and a second set of DMRS ports that correspond to a third coherent antenna port group or a fourth coherent antenna port group, wherein two most significant bits of the four bit-value are to identify the first DMRS port from the first set of DMRS ports as being associated with the first PTRS port and two least-significant bits of the four bit-value are to identify the second DMRS port from the second set of DMRS ports as being associated with the second PTRS port.

Example 10 includes the method of example 7 or some other example herein, wherein the eight DMRS ports include a first set of DMRS ports and a second set of DMRS ports, the first set of DMRS ports having a first subset that corresponds to a first coherent antenna port group and a second subset that corresponds to a second coherent antenna port group, the second set of DMRS ports having a first subset that correspond to a third coherent antenna port group and a second subset that corresponds to a fourth coherent antenna port group, wherein two most significant bits of the four bit-value are to identify the first DMRS port from the first or second subset of the first set of DMRS ports as being associated with the first PTRS port and two least-significant bits of the four bit-value are to identify the second DMRS port from the first or second subset of the second set of DMRS ports as being associated with the second PTRS port.

Example 11 includes the method of example 1 or some other example herein, wherein the PUSCH transmission comprises a first codeword associated with a first plurality of DMRS ports, a second codeword associated with a second plurality of DMRS ports, and the method further comprises: selecting the first DMRS port from the first plurality of DMRS ports; and selecting the second DMRS port from the second plurality of DMRS ports.

Example 12 includes the method of example 1 or some other example herein, wherein the PUSCH configuration is to configure the codebook-based 8-Tx uplink operation with a non-coherent mode in which eight antenna ports are arranged in two coherent antenna port groups.

Example 13 includes the method of example 1 or some other example herein, wherein the PUSCH transmission comprises a first codeword associated with the first PTRS port and a second codeword associated with the second PTRS port, transmitting the PTRS with the first PTRS port includes encoding the PTRS on a first frequency resource with a first time-domain density, transmitting the PTRS with the second PTRS port includes encoding the PTRS on a second frequency resource with a second time-domain density that is less than the first time-domain density, and a symbol has a first resource element (RE) at the first frequency resource that is used to transmit the PTRS with the first PTRS port and a second RE at the second frequency resource is omitted or is used to transmit a DMRS or the PUSCH transmission.

Example 14 includes a method of example 1 or some other example herein, wherein the DCI is to schedule the PUSCH transmission as four-layers and the method further comprises: receiving a PUSCH configuration to configure codebook-based 8-transmitter (Tx) uplink operation with a non-coherent mode in which eight antenna ports are arranged in eight coherent antenna port groups; and transmitting the PUSCH transmission as a non-full-power transmission when four-layer PUSCH is scheduled.

Example 15 includes the method of example 1 or some other example herein, wherein the DCI is to schedule the PUSCH transmission as four-layers and the method further comprises: receiving a PUSCH configuration to configure codebook-based 8-transmitter (Tx) uplink operation with a non-coherent mode in which eight antenna ports are arranged in eight coherent antenna port groups; and transmitting the PUSCH transmission as a full-power transmission based on an identity matrix.

Example 16 includes the method of example 15 or some other example herein, wherein transmitting the PUSCH transmission comprises: transmitting a first layer of the four layers with antenna ports from two antenna port groups of the eight coherent antenna port groups.

Example 17 includes a method to be implemented by a base station, the method comprising: receiving, from a user equipment (UE), capability information to indicate the UE supports configuration of sounding reference signal (SRS) resources of an SRS resource set on one or more port combinations; generating configuration information to configure an SRS resource of the SRS resource set based on the capability information; and transmitting the configuration information to the UE.

Example 18 includes the method of example 17 or some other example herein, wherein the one or more port combinations are: 1 port and 8 ports; 2 ports and 8 ports; 4 ports and 8 ports; 1 port, 2 ports, and 8 ports; 1 port, 4 ports, and 8 ports; 2 ports, 4 ports, and 8 ports; 1 port, 2 ports, 4 ports, and 8 ports.

Example 19 includes the method of example 17 or some other example herein, wherein the capability information comprises a 3-bit value, wherein a first bit of the 3-bit value indicates whether the UE supports a one-port SRS resource, a second bit of the 3-bit value indicates whether the UE supports a two-port SRS resource, and a third bit of the 3-bit value indicates whether the UE supports a four-port SRS resource.

Example 20 includes the method of example 17 or some other example herein, wherein the capability information is to indicate the UE supports configuration of SRS resources on ports of a plurality of predetermined ports that are above a minimum number or below a maximum number.

Example 21 includes a method of operating a base station, the method comprising: transmitting, to a user equipment, a physical uplink shared channel (PUSCH) configuration to configure codebook-based 8-transmitter (Tx) uplink operation with a full-coherent mode in which eight antenna ports are arranged in one coherent antenna port group, wherein the PUSCH configuration is to further configure a maximum rank for PUSCH transmissions; and transmitting downlink control information (DCI) to schedule a PUSCH transmission based on the PUSCH configuration, wherein the DCI includes a precoding-information-and-number-of-layers field having a number of bits that is based on the maximum rank.

Example 22 includes the method of example 21 or some other example herein, wherein the maximum rank is one and the number of bits is four; the maximum rank is two and the number of bits is six; or the maximum rank is three or greater and the number of bits is seven.

Example 23 includes the method of example 21 or some other example herein, wherein the number of bits is ┌log₂{Σᵣ₌₁^{maxRank}Nᵣ}┐, where maxRank is the maximum rank, r is a configured transmission rank, and Nr is a number of transmit precoder matrix indicators (TPMIs) associated with the rank and an antenna configuration of the UE.

Another example may include an apparatus comprising means to perform one or more elements of a method described in or related to any of examples 1-23, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-23, or any other method or process described herein.

Another example may include an apparatus comprising logic, modules, or circuitry to perform one or more elements of a method described in or related to any of examples 1-23, or any other method or process described herein.

Another example may include a method, technique, or process as described in or related to any of examples 1-23, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-23, or portions thereof.

Another example may include a signal as described in or related to any of examples 1-23, or portions or parts thereof.

Another example may include a datagram, information element, packet, frame, segment, PDU, or message as described in or related to any of examples 1-23, or portions or parts thereof, or otherwise described in the present disclosure.

Another example may include a signal encoded with data as described in or related to any of examples 1-23, or portions or parts thereof, or otherwise described in the present disclosure.

Another example may include a signal encoded with a datagram, IE, packet, frame, segment, PDU, or message as described in or related to any of examples 1-23, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-23, or portions thereof.

Another example may include a computer program comprising instructions, wherein execution of the program by a processing element is to cause the processing element to carry out the method, techniques, or process as described in or related to any of examples 1-23, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. One or more non-transitory, computer-readable media having instructions that, when executed, cause processing circuitry to:
process a physical uplink shared channel (PUSCH) configuration to configure codebook-based 8-transmitter (Tx) uplink operation;
identify up to eight demodulation reference signal (DMRS) ports associated with a PUSCH transmission;
determine, based on downlink control information (DCI) that schedules the PUSCH transmission, a first association between a first DMRS port of the up to eight DMRS ports and a first phase tracking reference signal (PTRS) port and a second association between a second DMRS port of the up to eight DMRS ports and a second PTRS port; and
generate a PTRS to be transmitted using the first PTRS port based on the first association and using the second PTRS port based on the second association.

2. The one or more non-transitory, computer-readable media of claim 1, wherein the PUSCH configuration is to configure the codebook-based 8-Tx uplink operation with a partial coherent mode in which eight PUSCH antenna ports are arranged in two coherent antenna port groups.

3. The one or more non-transitory, computer-readable media of claim 2, wherein the first DMRS port corresponds to a PUSCH antenna port 1000, 1001, 1004, or 1005 and the second DMRS port corresponds to a PUSCH antenna port 1002, 1003, 1006, or 1007.

4. The one or more non-transitory, computer-readable media of claim 1, wherein the PUSCH configuration is to configure the codebook-based 8-Tx uplink operation with a partial coherent mode in which eight PUSCH antenna ports are arranged in four coherent antenna port groups.

5. The one or more non-transitory, computer-readable media of claim 4, wherein:
the first DMRS port corresponds to PUSCH antenna port 1000, 1001, 1004, or 1005 and the second DMRS port corresponds to PUSCH antenna port 1002, 1003, 1006, or 1007;
the first DMRS port corresponds to PUSCH antenna port 1000, 1002, 1004, or 1006 and the second DMRS port corresponds to PUSCH antenna port 1001, 1003, 1005, or 1007; or
the first DMRS port corresponds to PUSCH antenna port 1000, 1003, 1004, or 1007 and the second DMRS port corresponds to PUSCH antenna port 1001, 1002, 1005, or 1006.

6. The one or more non-transitory, computer-readable media of claim 1, wherein the PUSCH configuration is to configure the codebook-based 8-Tx uplink operation with a non-coherent mode in which eight antenna ports are arranged in two coherent antenna port groups.

7. The one or more non-transitory, computer-readable media of claim 1, wherein the instructions, when executed, further cause the processing circuitry to:
identify, based on the DCI, a first precoder associated with the first DMRS port and a second precoder associated with the second DMRS port; and
generate the PTRS to be transmitted using the first PTRS port based on the first precoder and using the second PTRS port based on the second precoder.

8. The one or more non-transitory, computer-readable media of claim 1, wherein the DCI is DCI format 0_1 or 0_2 and comprises a PTRS-DMRS association field set with a four-bit value, and the first association and the second association is determined based on the four-bit value.

9. The one or more non-transitory, computer-readable media of claim 1, wherein the PUSCH transmission comprises a first codeword associated with a first plurality of DMRS ports, a second codeword associated with a second plurality of DMRS ports, and the instructions, when executed, further cause the processing circuitry to:
select the first DMRS port from the first plurality of DMRS ports; and
select the second DMRS port from the second plurality of DMRS ports.

10. The one or more non-transitory, computer-readable media of claim 1, wherein the PUSCH transmission comprises a first codeword associated with the first PTRS port and a second codeword associated with the second PTRS port, generating the PTRS to be transmitted with the first PTRS port includes encoding the PTRS on a first frequency resource with a first time-domain density, transmitting the PTRS with the second PTRS port includes encoding the PTRS on a second frequency resource with a second time-domain density that is less than the first time-domain density, and a symbol has a first resource element (RE) at the first frequency resource that is used to transmit the PTRS with the first PTRS port and a second RE at the second frequency resource is omitted or is used to transmit a DMRS or the PUSCH transmission.

11. The one or more non-transitory, computer-readable media of claim 1, wherein the DCI is to schedule the PUSCH transmission as a four-layer transmission, the PUSCH configuration is to configure codebook-based 8-Tx uplink operation with a non-coherent mode in which eight antenna ports are arranged in eight coherent antenna port groups, and the instructions, when executed, further cause the processing circuitry to:
generate the PUSCH transmission to be transmitted as a non-full-power transmission based on scheduling of the PUSCH transmission as a four-layer transmission.

12. The one or more non-transitory computer-readable media of claim 1, wherein the DCI is to schedule the PUSCH transmission as a four-layer transmission, the PUSCH configuration is to configure codebook-based 8-Tx uplink operation with a non-coherent mode in which eight antenna ports are arranged in eight coherent antenna port groups, and the instructions, when executed, further cause the processing circuitry to:
generate the PUSCH transmission as a full-power transmission based on an identity matrix.

13. The one or more non-transitory computer-readable media of claim 12, wherein to generate the PUSCH transmission the processing circuitry is to:
generate a first layer with antenna ports from two antenna port groups of the eight coherent antenna port groups.

14. An apparatus comprising:
processing circuitry to:
process capability information that indicates a user equipment (UE) supports configuration of sounding reference signal (SRS) resources of an SRS resource set on one or more port combinations;
generate configuration information to configure an SRS resource of the SRS resource set based on the capability information; and
generate a signal to include the configuration information; and
interface circuitry coupled to the processing circuitry to enable communication.

15. The apparatus of claim 14, wherein the one or more port combinations are: 1 port and 8 ports; 2 ports and 8 ports; 4 ports and 8 ports; 1 port, 2 ports, and 8 ports; 1 port, 4 ports, and 8 ports; 2 ports, 4 ports, and 8 ports; or 1 port, 2 ports, 4 ports, and 8 ports.

16. The apparatus of claim 14, wherein the capability information comprises a 3-bit value, wherein a first bit of the 3-bit value indicates whether the UE supports a one-port SRS resource, a second bit of the 3-bit value indicates whether the UE supports a two-port SRS resource, and a third bit of the 3-bit value indicates whether the UE supports a four-port SRS resource.

17. The apparatus of claim 14, wherein the capability information is to indicate the UE supports configuration of SRS resources on ports of a plurality of predetermined ports that are above a minimum number or below a maximum number.

18. (canceled)

19. (canceled)

20. (canceled)

21. A method comprising:
receiving a physical uplink shared channel (PUSCH) configuration to configure codebook-based 8-transmitter (Tx) uplink operation with a non-coherent mode in which eight antenna ports are arranged in eight coherent antenna port groups;
receiving a downlink control information (DCI) to schedule a PUSCH transmission as a four-layer transmission;
identifying a precoding matrix for the PUSCH transmission as a full power transmission based on the PUSCH configuration and the DCI, wherein the precoding matrix is based on an identity matrix; and
generating the PUSCH transmission for transmission using the precoding matrix.

22. The method of claim 21, wherein generating the PUSCH transmission includes generating a first layer with antenna ports from two antenna port groups of the eight coherent antenna port groups.

23. The method of claim 21, further comprising:
determining, based on the DCI, a first antenna port of the eight antenna ports that is associated with a first phase tracking reference signal (PTRS) port and a second antenna port of the eight antenna ports that is associated with a second PTRS port; and
generating a PTRS for transmission using the first and second PTRS ports.
